(19) United States
(12) Patent Application Publication
(10) Pub. No.: US 2005/0150400 A1
(43) Pub. Date: Jul. 14, 2005

(54) Multi-functional peripheral with rotatable and slidable scanner module

(76) Inventor: Nien-Chin Lin, Shulin City (TW)

Correspondence Address: RABIN & Berdo, PC, 1101 14TH STREET, NW, SUITE 500, WASHINGTON, DC, 20005, US

(21) Appl. No.: 11/025,062

(22) Filed: Dec. 30, 2004

(30) Foreign Application Priority Data
Jan. 12, 2004 (TW) 93100721

(51) Int. Cl. B41F 17/00

(52) U.S. Cl. 101/35

(57) ABSTRACT

A mechanism applied to a multi-functional peripheral (MFP) includes a pair of slots and engaging portions. The slots are respectively formed on the inner walls of two side surfaces of a printer module of the MFP, and the engaging portions such as two pins are respectively formed on two lateral sides of a scanner module of the MFP. The printer module is disposed below the scanner module for proving printing function. The two pins protruding from the housing of the scanner module are rotatably and slidably engaged with the corresponding slots. The mechanism of the invention allows not only the pivoting but also the sliding of the scanner module on the printer module. The user can rotate the scanner module by 90 degrees, or the scanner module can be moved behind the printer module in order to save the space occupied by the MFP.

This application claims the benefit of Taiwan application Serial No. 093100721, filed Jan. 12, 2004, the subject matter of which is incorporated herein by reference.

### BACKGROUND OF THE INVENTION

1. Field of the Invention

The invention relates in general to a multi-functional peripheral (MFP) with a rotatable and slidable scanner module, and more particularly to a MFP having a scanner module and a printer module that can be assembled in a slidable and rotatable way.

2. Description of the Related Art

The multi-functional peripheral (MFP) available in the market integrates multiple computer peripheral systems so as to save more office space. The typical MFP may include at least two systems of printing, scanning, copy and fax functions; the expensive MFP even includes all of the functions. Because the technology is gradually developed, the overall size of MFP is gradually reduced, more functions is integrated and the price of MFP is remarkably decreased, the MFP becomes popular in the consumer market. The MFP not only provides a good choice for the SOHO (Small Office, Home Office) people, but also becomes a newest member for the digital image integration.

The design mainstream of the typical MFP is to locate the scanner module above the printer module. The printer module can be made very small due to the well-developing technology. Typically, the scanner module must have a platen with at least A4-sized (21 cm×29.7 cm) dimension so that an A4 sheet can be scanned. Thus, when the flatbed-scanner module is horizontally placed on the printer module, a portion of the scanner module will protrude. Therefore, the MFP occupies a larger space due to the platen width of the scanner module.

FIG. 1 is a schematic illustration showing a conventional MFP. The MFP currently sold in the market has an unchangeable size after being assembled. When the maintenance such as replacing the inkjet print head or eliminating the paper jam of the printer module is performed, one side of the scanner module 10 is lifted and a support 30 is required for supporting the scanner module 10 from dropping. With the support 30, the scanner module 10 won't fall down to hurt the user or damage the printer module 20 during the maintenance. However, only a small angle (about 30 degrees) is opened between the scanner module 10 and the printer module 20, and it is inconvenient to perform the maintenance of the printer module. Also, the conventional MFP has no way to save the occupied space by changing the relative position between the scanner module and the printer module.

### SUMMARY OF THE INVENTION

It is therefore an object of the invention to provide a mechanism capable of changing a relative position between a scanner module and a printer module of a multi-functional peripheral (MFP) by way of rotating and sliding. Accordingly, different combinations of the scanner module and the printer module with different angles and different relative positions can be achieved. The user can rotate the scanner module by 90 degrees, or slide the scanner module to a position behind the printer module so as to save the space occupied by the MFP.

The invention achieves the above-identified object by providing a first rotatable mechanism for pivoting the scanner module on the printer module to at least 90 degrees so as to reduce the space occupied by the scanner module.

The invention also achieves the above-identified object by providing a second mechanism, which is applied to a multi-functional peripheral (MFP) for changing a relative position between a scanner module and a printer module below the scanner module. The mechanism includes a pair of slots and engaging portions. The slots are respectively formed on the inner walls of two side surfaces of the printer module. The engaging portions, such as two pins, are respectively formed on two lateral sides of the scanner module and rotatably engaged with the corresponding slots. When the scanner module is opened to an opening angle relative to the printer module, a relative position between the scanner module and the printer module can be changed by sliding the pins in the slots. Each lateral side of the scanner module is further disposed with a hinge apparatus so as to rotate the scanner module on the printer module. The maximum rotation may reach an angle of 90 degrees.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (prior art) is a schematic illustration showing a conventional MFP.

FIG. 2 schematically illustrates a multi-functional peripheral (MFP) according to the embodiment of the invention.

FIG. 3 schematically illustrates an open angle of 90 degrees between the scanner module and the printer module according to a first embodiment of the invention.

FIG. 4 schematically illustrates an open angle smaller than 90 degrees between the scanner module and the printer module of FIG. 2 according to the second embodiment of the invention.

FIG. 5 is a perspective and sectional view of FIG. 4.

FIG. 6 schematically illustrates another combination of the scanner module and the printer module according to a second embodiment of the invention.

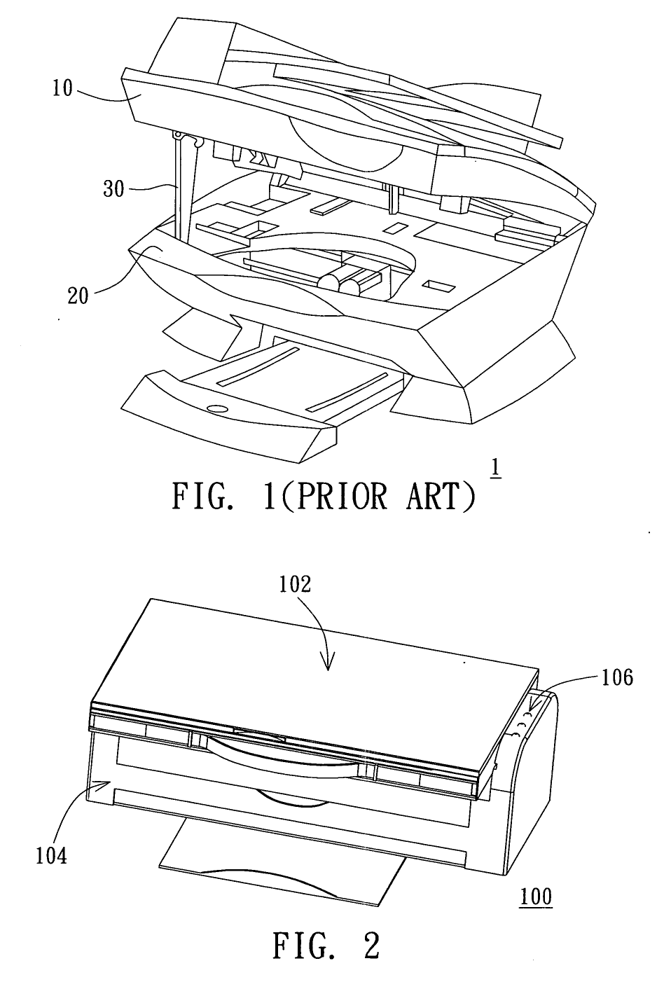

### DETAILED DESCRIPTION OF THE INVENTION

The invention provides a slidable or/and rotatable mechanism so that a scanner module and a printer module of a multi-functional peripheral (MFP) can be combined with different angles. By rotating the scanner module, the angle between the scanner module and the printer module can be 90 degrees. Also, the scanner module can be slidably moved to the position behind the printer module so as to save the overall space occupied by the MFP.

The embodiments disclosed herein are for illustrating the invention, but not for limiting the scope of the invention. In order to prevent the features of the embodiments from being obscured, only the important and associated components are shown in the drawings.

### First Embodiment

FIG. 2 schematically illustrates a multi-functional peripheral (MFP) according to the embodiment of the invention. The MFP 100 has a scanner module (e.g., a flatbed scanner module) 102 and a printer module 104 below the scanner module 102. A control panel 106 is disposed on one of two side surfaces of the printer module 104, facilitating the user to select the to-be-performed function such as scanning, copy or printing. As shown in FIG. 2, the width of the scanner module 102 is greater than that of the printer module 104. In addition, the MFP 100 of FIG. 2 has an U-type sheet-feeding path, which means a sheet being inputted into the MFP from the front end of the MFP, and also outputted from the front end of the MFP.

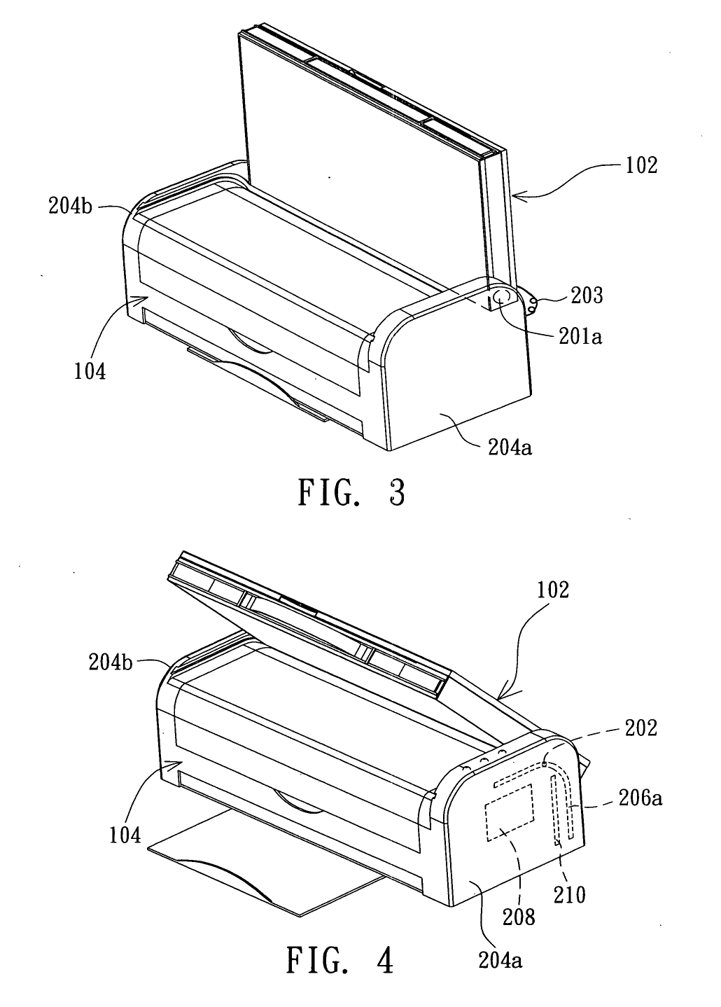

In the first embodiment, the different combination angles between the scanner module 102 and the printer module 104 are achieved by way of rotation. FIG. 3 schematically illustrates an open angle of 90 degrees between the scanner module and the printer module according to a first embodiment of the invention. A hinge apparatus 201a is disposed in the two lateral sides of the scanner module 102 and the side surfaces 204a, 204b of the printer module 104. For example, the hinge apparatus 201a comprises a rotating portion and a receiving portion; the rotating portion is formed at the lateral sides of the scanner module 102 and the receiving portion is relatively formed at the side surfaces 204a, 204b of the printer module 104. The rotating portion assembled with the receiving portion allows the pivoting-of the scanner module 102 on the printer module 104. As shown in FIG. 3, when the scanner module 102 is not in use, it can be rotated upwards to a vertical state, in which the angle between the scanner module 102 and printer module 104 is 90 degrees, so that the space occupied by the MFP on the table can be saved. Accordingly, the scanner module 102 having a document platen is pivoted on the printer module 104 through the hinge apparatus 201a, and the document platen can substantially extend along a direction vertical to the printer module by rotating the scanner module. A cable for electrically connecting the scanner module 102 and the printer module 104 can be preferably hidden in the hinge apparatus 201a for appearance concern. Alternatively, an external cable 203 electrically connecting the scanner module 102 to the printer module 104 can be used, as shown in FIG. 3. No special limitation exists in the connection way.

### Second Embodiment

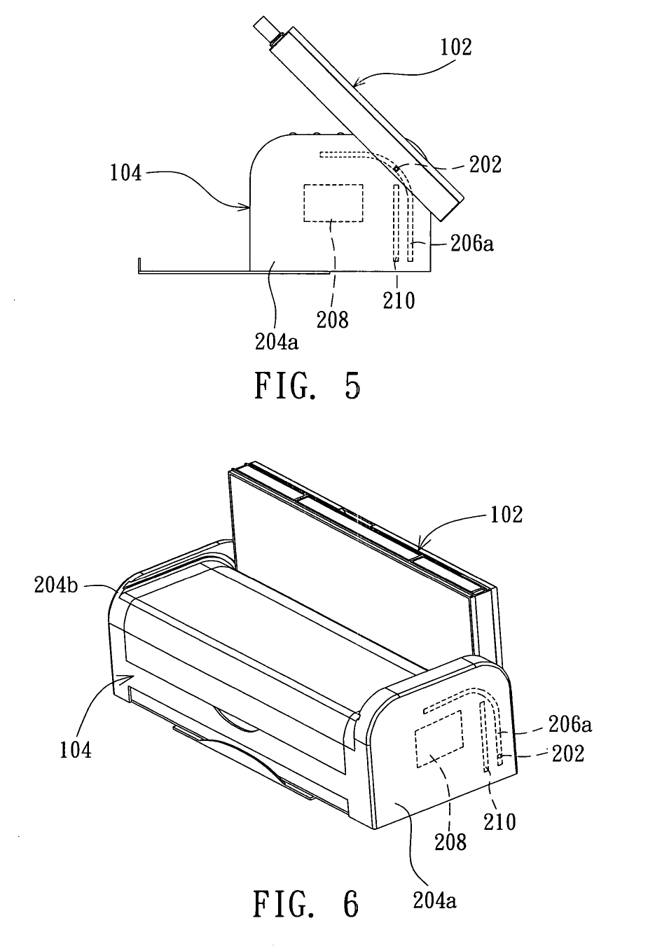

In the second embodiment with reference to FIG. 2 at the same time, different combination angles between the scanner module 102 and the printer module 104 are achieved by ways of rotating and sliding. FIG. 4 schematically illustrates an open angle smaller than 90 degrees between the scanner module and the printer module of FIG. 2 according to the second embodiment of the invention. FIG. 5 is a perspective and sectional view of FIG. 4. The engaging portions, such as the pins 202 (or the cylinder), are respectively formed at two lateral sides of the scanner module 102. The slots 206a and 206b (slot 206b is not shown in the drawing owing to the angle of view) are formed on the inner walls of the surfaces 204a and 204b of the printer module 104. The pins 202 are rotatably engaged with the slots 206a and 206b, and the maximum rotation angle between the scanner module 102 and the printer module 104 may reach 90 degrees or more. In addition, a hinge apparatus described in the first embodiment can be applied herein; for example, the hinge apparatus and the pins thereof (sliding in the slots 206a and 206b) provide the rotating and sliding movement of the scanner module 102.

When the user does not need to use the scanner module 102, the scanner module 102 can be opened to a desired position. By sliding the engaging portions such as the pins 202 in the slots 206a and 206b, a relative position between the scanner module 102 and the printer module 104 can be changed.

In addition, a printed circuit board (PCB) 208 is disposed at a side surface of the printer module 104, and the scanner module 102 is electrically connected to the PCB 208 through a cable (not shown). To prevent the cable connecting the printer module 104 to the PCB 208 from being influenced during the sliding movement of the scanner module 102, an opening 210 adjacent to the slot is preferably formed on the inner wall of the side surface of the printer module 104 in the second embodiment, so that the cable can be smoothly moved in the opening 210 while the scanner module 102 is sliding. The shape and position of the opening 210 are not limited and are preferably formed for maintaining the shortest length of the cable.

FIG. 6 schematically illustrates another combination of the scanner module and the printer module according to a second embodiment of the invention. When the user needs to use the scanning function of the MFP 100, the angle between the scanner module 102 and the printer module 104 is 0 degree, as shown in FIG. 2. When the user wants to use other functions (such as the printing function), the scanner module 102 can be opened by rotation, and then the scanner module 102 slides along the slots 206a and 206b to achieve a setting position; in the second embodiment, the angle between the scanner module 102 and the printer module 104 becomes 90 degrees after the scanner module 102 reaches the setting position, as shown in FIG. 6.

Of course, the electrical connection between the scanner module 102 and the printer module 104 in the second embodiment can also be achieved by way of external connection (as depicted in FIG. 3). At this time, the opening 210 for accommodating the cable can be omitted. Noted that the electrical connection way between the scanner module 102 and the printer module 104 of the invention is not particularly limited.

According to the aforementioned description, using the rotatable or/and slidable mechanism of the invention can obtain an optimum combination of the scanner module and the printer module according to the user's requirement. The advantages of greatly reducing the size of the MFP and saving the space occupied by the MFP can also be achieved. In addition, the scanner module can be rotated to an open angle of 90 degrees relative to the printer module. Compared to the prior art having the open angle of just about 30 degrees, the user can replace the ink cartridge in the printer module or eliminate the paper jam in a more convenient and laborsaving way when the MFP applied with the mechanism of the invention is used.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A position changing mechanism, applied to a multi-functional peripheral (MFP) for changing a relative position between a scanner module and a printer module below the scanner module, the mechanism comprising:
a pair of slots, respectively formed on the inner walls of two side surfaces of the printer module; and
two pins, respectively formed on two lateral sides of the scanner module and rotatably engaged with the slots,
when the scanner module is opened to an opening angle relative to the printer module, the relative position between the scanner module and the printer module can be changed by sliding the pins in the slots.

2. The mechanism according to claim 1, wherein each lateral side of the scanner module is disposed with a hinge apparatus for rotating the scanner module on the printer module.

3. The mechanism according to claim 2, wherein a maximum rotation angle between the scanner module and the printer module is 90 degrees.

4. The mechanism according to claim 1, wherein the scanner module is electrically connected to the printer module.

5. The mechanism according to claim 4, wherein the scanner module is electrically connected to the printer module via an external cable.

6. The mechanism according to claim 4, wherein an opening is formed on at least one of the inner walls of the side surfaces of the printer module, for setting cable by which the scanner module and the printer module are electrically connected.

7. The mechanism according to claim 6, wherein the opening is adjacent to the slot.

8. The mechanism according to claim 7, wherein the opening is parallel to the slot, and the cable slides in the opening while the pins of the scanner module slide along the slots.

9. The mechanism according to claim 1, wherein when the MFP is being used, an angle between the scanner module and the printer module is 0 degree, and when the MFP is not used, the angle between the scanner module and the printer module is 90 degrees after the scanner module slides relatively on the printer module.

10. A multi-functional peripheral (MFP), comprising:
a scanner module having two lateral sides, each lateral side having an engaging portion; and
a printer module having two side surfaces, disposed below the scanner module, and each inner wall of two side surfaces of the printer module having a slot, and the engaging portions rotatably and slidably received within the corresponding slots,
wherein the scanner module moves relative to the printer module when by sliding the engaging portions within the slots.

11. The MFP according to claim 10, wherein the engaging portion is a pin.

12. The MFP according to claim 11, wherein the engaging portion is a cylinder.

13. The MFP according to claim 10, wherein each lateral side of the scanner module is disposed with a hinge apparatus for rotating the scanner module on the printer module.

14. The MFP according to claim 13, wherein a maximum rotation angle between the scanner module and the printer module is 90 degrees.

15. The MFP according to claim 10, wherein the scanner module is electrically connected to the printer module.

16. The MFP according to claim 15, wherein the scanner module is electrically connected to the printer module via an external cable.

17. The MFP according to claim 15, wherein an opening is formed on at least one of the inner walls of the side surfaces of the printer module, for setting a cable by which the scanner module and the printer module are electrically connected.

18. The MFP according to claim 17, wherein the opening is adjacent to the slot.

19. The MFP according to claim 18, wherein the opening is parallel to the slot, and the cable slides in the opening while the pins of the scanner module slide along the slots.

20. The MFP according to claim 10, wherein when the MFP is being used, an angle between the scanner module and the printer module is 0 degrees, and when the MFP is not used, the angle between the scanner module and the printer module is 90 degrees after the scanner module slides relatively on the printer module.

21. A rotatable mechanism, applied to a multi-functional peripheral (MFP) for relatively rotating a scanner module to a printer module, and the printer module disposed below the scanner module, the rotatable mechanism comprising:
two receiving portions, respectively formed on the inner walls of two side surfaces of the printer module; and
two rotating portions, respectively formed on two lateral sides of the scanner module, and rotatably assembled with the receiving portions,
wherein the scanner module can be rotated by at least 90 degrees relative to the printer module such that a relative position between the scanner module and the printer module can be changed by way of rotation.

22. The mechanism according to claim 21, wherein the scanner module is electrically connected to the printer module.

23. The mechanism according to claim 22, wherein the scanner module is electrically connected to the printer module via an external cable.

24. The mechanism according to claim 22, wherein an opening is formed on at least one of the inner walls of the side surfaces of the printer module, for setting a cable by which the scanner module and the printer module are electrically connected.

25. A multi-functional peripheral (MFP), comprising:
a first sidewall and a second sidewall;
a printer module disposed between the first sidewall and the second sidewall; and
a scanner module disposed above the printer module, and two lateral sides of the scanner module respectively pivoted on the first sidewall and the second sidewall,
wherein the scanner module can be rotated by at least 90 degrees relative to the first sidewall and the second sidewall.

26. The MFP according to claim 25, wherein the scanner module is electrically connected to the printer module via an external cable.

27. The MFP according to claim 25, wherein the scanner module has a document platen, and the document platen can substantially extend along a direction vertical to the printer module by rotating the scanner module.
